(19) United States
(12) Patent Application Publication
(10) Pub. No.: US 2014/0149146 A1
(43) Pub. Date: May 29, 2014

(54) Dynamically Determining a Set of Threshold Interest Rates Associated with a Guaranteed Life Insurance Product

(71) Applicant: Transamerica Corporation, San Francisco, CA (US)

(72) Inventors: Mark Shickler, Los Angeles, CA (US); Michael Babikian, Glendale, CA (US); Phyllis Dilbeck, Glendale, CA (US); Donald Morden, Marina Del Rey, CA (US)

(73) Assignee: Transamerica Corporation, San Francisco, CA (US)

(21) Appl. No.: 14/092,184

(22) Filed: Nov. 27, 2013

Related U.S. Application Data
(60) Provisional application No. 61/730,786, filed on Nov. 28, 2012.

(51) Int. Cl. G06Q 40/08

(52) U.S. Cl. CPC G06Q 40/08
USPC 705/4

(57) ABSTRACT

Methods and apparatuses, including computer program products, are described for dynamically determining a set of threshold interest rates associated with a guaranteed life insurance product. A computing device determines an in-effect set of threshold interest rates for the product based on a target profit value for the product and applies the in-effect set of rates to an application for the product upon receipt of the application. The computing device determines periodically whether to modify the in-effect set of rates based on a comparison of an estimated profit value to the target profit value. If the computing device determines that the in-effect set of rates is to be modified, the computing device calculates a modified set of rates and applies the modified set of rates to the application on its issuance date, if the modified set of rates is higher than the set of rates currently applied.

### RELATED APPLICATIONS

The application claims priority to U.S. Provisional Patent Application No. 61/730,786, filed Nov. 28, 2012, the entirety of which is incorporated herein by reference.

### FIELD OF THE INVENTION

The subject matter of this application relates generally to methods and apparatuses, including computer program products, for dynamically determining a set of threshold interest rates associated with a guaranteed life insurance product.

### BACKGROUND OF THE INVENTION

Many insurance companies offer universal life insurance (often shortened to UL).

Under the terms of a typical UL policy, the excess of premium payments above the current premium expense charge are credited to the cash value of the policy. The cash value is credited each month with interest, and the policy is debited each month by certain expenses or charges, such as a cost of insurance (COI) charge as well as any other policy charges and fees which are drawn from the cash value. Interest credited to the account is determined either by formula or by the insurer, but generally has a contractual minimum rate. Under this model, it is possible for the UL policy to lose value such that the amount of expenses exceeds the net cash value of the policy. The policy then enters a grace period, during which the owner is required satisfy the shortfall or risk termination of the policy.

UL policies typically include a death benefit guarantee, where the death benefit of the policy is paid to a surviving beneficiary when the insured dies while the policy remains in force. However, in some cases, the death benefit guarantee is not available and terminates due to insufficient policy value. Certain UL policies include provisions that maintain the death benefit guarantee despite a loss in value that would ordinarily trigger the grace period and ultimately lead to termination, provided that certain conditions are met.

In some cases, an insurance company may elect to track eligibility for the death benefit guarantee in an account, sometimes called a shadow account or Policy Threshold that is separate from the main UL policy account. The value of the shadow account can be determined using a parallel accumulation value calculation. As with the main UL policy account, the shadow account is subject to certain fees and expenses, and also accrues interest at a specified rate or set of rates (called the Threshold Interest Rate or TIR). The TIR is frequently used as a basis for setting the consumer cost of the death benefit guarantee (or the entire policy), and the TIR for a particular policy is set at policy issuance.

Typically, the insurance company establishes the TIR for a particular UL product at launch of the product. Often, the TIR is calculated using data-intensive scenario models that require lengthy processing time. Once established, the TIR do not generally change until the launch of a new version of the product (which is typically several months to years away) due to the extensive computations needed in traditional modeling methods and establishing administrative system support of a new product.

### SUMMARY OF THE INVENTION

In general overview, the techniques described herein are related to using a computerized system to dynamically determine a set of threshold interest rates (TIRs) associated with a guaranteed life insurance product. The techniques leverage the processing speed and power of a computer-based system to provide the advantage of adjusting TIRs on a real-time, dynamic basis to account for fluctuations in market conditions and rates. In this respect, the insurance company offering the product is protected during low interest rate environments, as the TIRs and premiums associated with new insurance policies issued for the product can be updated quickly and accurately to match projected profit values. Similarly, the consumer gains the upside of higher interest rate environments as he or she can receive the benefit of higher TIRs.

The invention, in one aspect, features a computerized method for dynamically determining a set of threshold interest rates associated with a guaranteed life insurance product. A computing device determines an in-effect set of threshold interest rates for the guaranteed life insurance product based on a target profit value for the guaranteed life insurance product. The computing device applies the in-effect set of threshold interest rates to an application for the guaranteed life insurance product upon receipt of the application. The computing device determines, on a periodic basis, whether to modify the in-effect set of threshold interest rates based on a comparison of an estimated profit value of the guaranteed life insurance product to the target profit value. If the computing device determines that the in-effect set of threshold interest rates is to be modified, the computing device calculates a modified set of threshold interest rates and applies the modified set of threshold interest rates to the application for the guaranteed life insurance product on an issuance date of the product, if the modified set of threshold interest rates is higher than the set of threshold interest rates currently applied to the application.

The invention, in another aspect, features a computerized system for dynamically determining a set of threshold interest rates associated with a guaranteed life insurance product. The system includes a computing device configured to determine an in-effect set of threshold interest rates for the guaranteed life insurance product based on a target profit value for the guaranteed life insurance product and apply the in-effect set of threshold interest rates to an application for the guaranteed life insurance product upon receipt of the application. The computing device is configured to determine, on a periodic basis, whether to modify the in-effect set of threshold interest rates based on a comparison of an estimated profit value of the guaranteed life insurance product to the target profit value. If the computing device determines that the in-effect set of threshold interest rates is to be modified, the computing device is configured to calculate a modified set of threshold interest rates, and apply the modified set of threshold interest rates to the application for the guaranteed life insurance product on an issuance date of the product, if the modified set of threshold interest rates is higher than the set of threshold interest rates currently applied to the application.

The invention, in another aspect, features a computer program product tangibly embodied in a non-transitory computer readable medium, for dynamically determining a set of threshold interest rates associated with a guaranteed life insurance product. The computer program product includes instructions operable to cause a data processing apparatus to determine an in-effect set of threshold interest rates for the guaranteed life insurance product based on a target profit value for the guaranteed life insurance product and apply the in-effect set of threshold interest rates to an application for the guaranteed life insurance product upon receipt of the application. The computer program product includes instructions operable to cause the data processing apparatus to determine, on a periodic basis, whether to modify the in-effect set of threshold interest rates based on a comparison of an estimated profit value of the guaranteed life insurance product to the target profit value. If the apparatus determines that the in-effect set of threshold interest rates is to be modified, the computer program product includes instructions operable to cause the data processing apparatus to calculate a modified set of threshold interest rates, and apply the modified set of threshold interest rates to the application for the guaranteed life insurance product on an issuance date of the product, if the modified set of threshold interest rates is higher than the set of threshold interest rates currently applied to the application.

The invention, in another aspect, features a system for dynamically determining a set of threshold interest rates associated with a guaranteed life insurance product. The system includes means for determining an in-effect set of threshold interest rates for the guaranteed life insurance product based on a target profit value for the guaranteed life insurance product and means for applying the in-effect set of threshold interest rates to an application for the guaranteed life insurance product upon receipt of the application. The system includes means for determining, on a periodic basis, whether to modify the in-effect set of threshold interest rates based on a comparison of an estimated profit value of the guaranteed life insurance product to the target profit value. If the system determines that the in-effect set of threshold interest rates is to be modified, the system includes means for calculating a modified set of threshold interest rates, and means for applying the modified set of threshold interest rates to the application for the guaranteed life insurance product on an issuance date of the product, if the modified set of threshold interest rates is higher than the set of threshold interest rates currently applied to the application.

In some embodiments, any of the above aspects can include one or more of the following features. In some embodiments, determining whether to modify the in-effect set of threshold interest rates includes determining the estimated profit value using a correlated scenario based on market information associated with a current period, comparing the estimated profit value with the target profit value, and determining to modify the in-effect set of threshold interest rates if the estimated profit value differs from the target profit value by more than a sufficient amount. In some embodiments, the market information includes a set of swap curves. In some embodiments, the target profit value represents a profit measure calculated on a quarterly basis.

In some embodiments, determining the estimated profit value further includes determining a shift-down profit value using a correlated scenario based on lower market values, and determining a shift-up profit value using a correlated scenario based on higher market values. In some embodiments, the calculation of the modified set of threshold interest rates is based on the estimated profit value, the shift-down profit value, and/or the shift-up profit value.

In some embodiments, determining an in-effect set of threshold interest rates includes determining the target profit value using a stochastic scenario based on market values from the most recent quarter, determining a second profit value using a correlated scenario based on market values from the most recent quarter, and calculating the in-effect set of threshold interest rates based on the target profit value and the second profit value. In some embodiments, determining an in-effect set of threshold interest rates further includes determining a shift-down set of threshold interest rates using a stochastic scenario based on lower market values, and determining a shift-up set of threshold interest rates using a stochastic scenario based on higher market values. In some embodiments, determining an in-effect set of threshold interest rates further includes determining an in-effect premium rate for the guaranteed life insurance product.

In some embodiments, applying the in-effect set of threshold interest rates to an application further includes locking in the in-effect set of threshold interest rates for a predetermined period of time (rate lock period). In some embodiments, determining whether to modify the in-effect set of threshold interest rates is performed on a weekly basis.

In some embodiments, an illustration is generated that is associated with the application for the guaranteed life insurance product that includes information associated with the in-effect set of threshold interest rates and/or the modified set of threshold interest rates, and the computing device transmits the illustration to a remote computing device. In some embodiments, the modified set of threshold interest rates takes effect several days after the calculation of the modified set of threshold interest rates is performed. In some embodiments, the modified set of threshold interest rates is transmitted to a remote computing device before taking effect.

In some embodiments, applying the in-effect set of threshold interest rates further comprises assigning a rate lock date to the application based on the date that the application is received, and determining a rate lock expiry date based on the rate lock date and a rate lock period. In some embodiments, the computing device generates printed correspondence including the rate lock date and the rate lock expiry date upon receipt of the application, and transmits electronic copies of the printed correspondence to an electronic record retention system and to a website. In some embodiments, the computing device determines a warning period prior to the rate lock expiry date, and triggers the steps of generating printed correspondence and transmitting electronic copies if the current date falls within the warning period.

In some embodiments, if the application is still pending and the rate lock period has expired, the computing device assigns a new rate lock date to the application and determines a new rate lock expiry date based on the new rate lock date and a rate lock period. In some embodiments, the computing device generates printed correspondence including the new rate lock date and the new rate lock expiry date and transmits electronic copies of the printed correspondence to an electronic record retention system and to a website. In some embodiments, the computing device determines a warning period prior to the new rate lock expiry date and triggers the steps of generating printed correspondence and transmitting electronic copies if the current date falls within the warning period.

The aspects of the invention include computer-based implementations such as a computer system including software modules and hardware modules, connected to a communications network and operable to perform the methods and processes described herein. The computer system can comprise one or several processor-based computing devices that control physical and/or logical modules to implement aspects of the invention. Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for dynamically determining a set of threshold interest rates associated with a guaranteed life insurance product.

FIG. 2 is a flow diagram of a method for dynamically determining a set of threshold interest rates associated with a guaranteed life insurance product.

FIG. 3 is a detailed flow diagram of a method for determining an in-effect set of threshold interest rates based on a target profit value.

FIG. 4 is a detailed flow diagram of a method for determining, on a periodic basis, whether to modify the in-effect set of threshold interest rates based on a comparison of an estimated profit value to the target profit value.

FIG. 5 is a block diagram of a timeline for determining whether to modify the in-effect set of threshold interest rates and availability of the modified threshold interest rates to newly-received and issuing applications.

### DETAILED DESCRIPTION

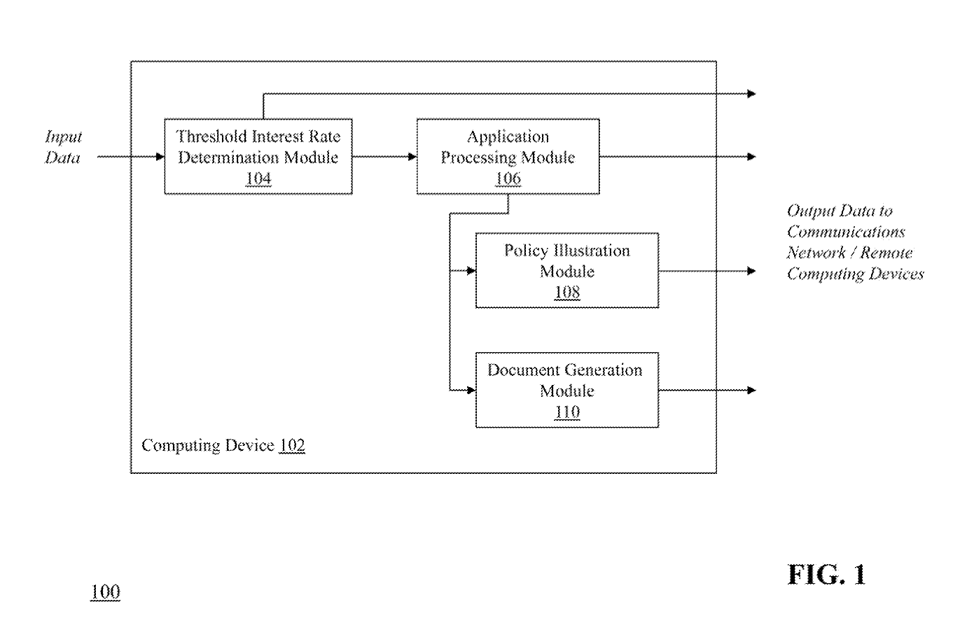

FIG. 1 is a block diagram of a system 100 for dynamically determining a set of threshold interest rates associated with a guaranteed life insurance product. The system 100 includes a computing device 102 for implementing the computer processing in accordance with computer-implemented embodiments of the invention. The methods described herein may be achieved by implementing program procedures, modules and/or software executed on, for example, a processor-based computing device or network of computing devices. The computing device 102 is connected to one or more communications networks that enable the computing device to receive data from and transmit data to other computing devices that assist the computing device 102 in performing the processes described herein. The computing device 102 is configurable to include automated processing for the methods of the invention, such as triggering mechanisms that evaluate certain data and system events, and respond to determinations made through use of the triggering mechanisms by performing additional actions.

The computing device 102 includes a threshold interest rate (TIR) determination module 104, an application processing module 106, a policy illustration module 108, and a document generation module 110. The TIR determination module 104, application processing module 106, policy illustration module 108, and document generation module 110 are hardware and/or software modules located in the computing device 102 and used to execute the method for dynamically determining a set of threshold interest rates associated with a guaranteed life insurance product. In some embodiments, the computing device 102 is a server computing device located on a communication network (e.g., Internet, WAN, or LAN) and communicating with other computing devices (not shown). In some embodiments, the functionality of the TIR determination module 104, application processing module 106, policy illustration module 108, and document generation module 110 is distributed among a plurality of computing devices. It should be appreciated that any number of computing devices, arranged in a variety of architectures, resources, and configurations (e.g., cluster computing, virtual computing, cloud computing) can be used without departing from the spirit or scope of the invention.

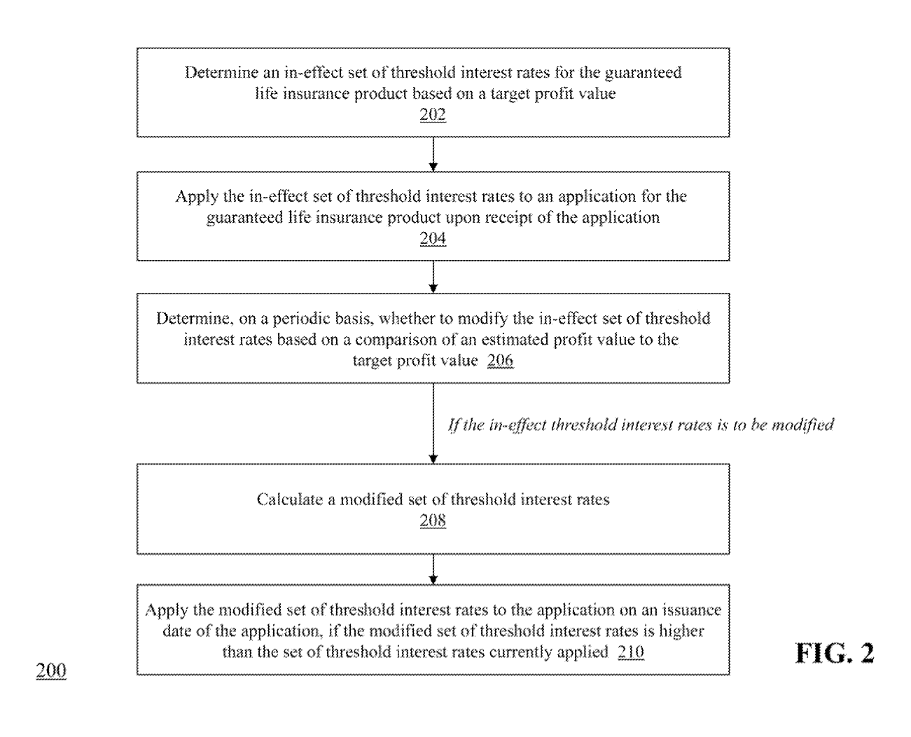

FIG. 2 is a flow diagram of a method 200 for dynamically determining a set of threshold interest rates associated with a guaranteed life insurance product, using the system 100 of FIG. 1. The TIR determination module 104 of the computing device 102 determines (202) an in-effect set of threshold interest rates for the guaranteed life insurance product based on a target profit value for the guaranteed life insurance product. The application processing module 104 of the computing device 102 applies (204) the in-effect set of threshold interest rates to an application for the guaranteed life insurance product upon receipt of the application. In some embodiments, receipt of the application is considered the date on which a fully-completed application is received by the central processing office of the insurance company.

The TIR determination module 104 of the computing device 102 determines (206) on a periodic basis whether to modify the in-effect set of threshold interest rates based on a comparison of an estimated profit value of the guaranteed life insurance product to the target profit value. If the TIR determination module 104 determines that the in-effect set of threshold interest rates is to be modified, the TIR determination module 104 calculates (208) a modified set of threshold interest rates and applies (210) the modified set of threshold interest rates to the application for the guaranteed life insurance product on an issuance date of the product, if the modified set of threshold interest rates is higher than the set of threshold interest rates currently applied to the application.

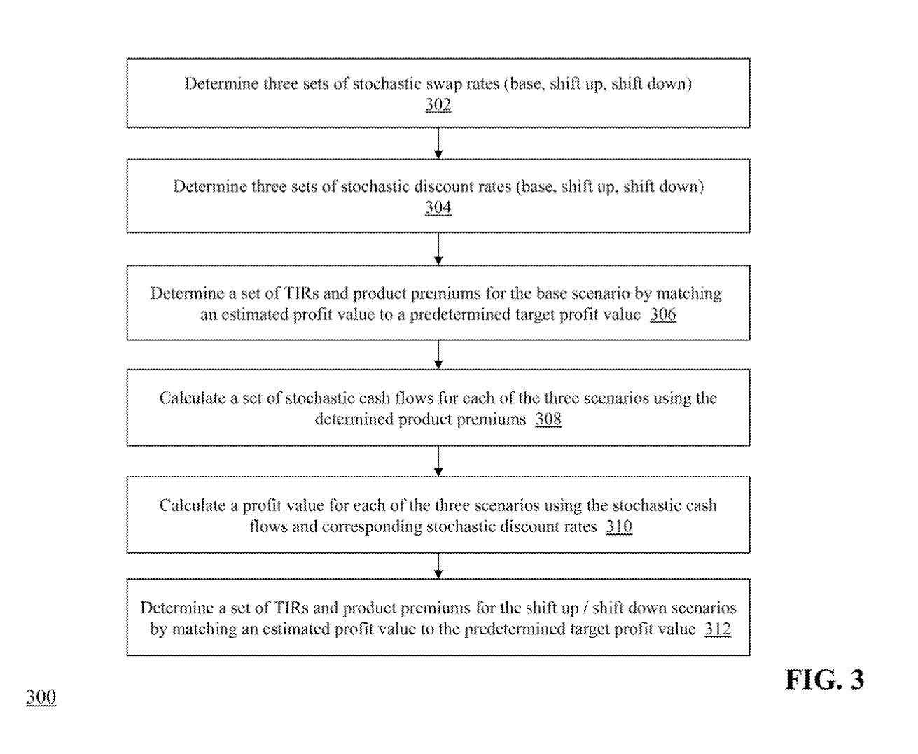

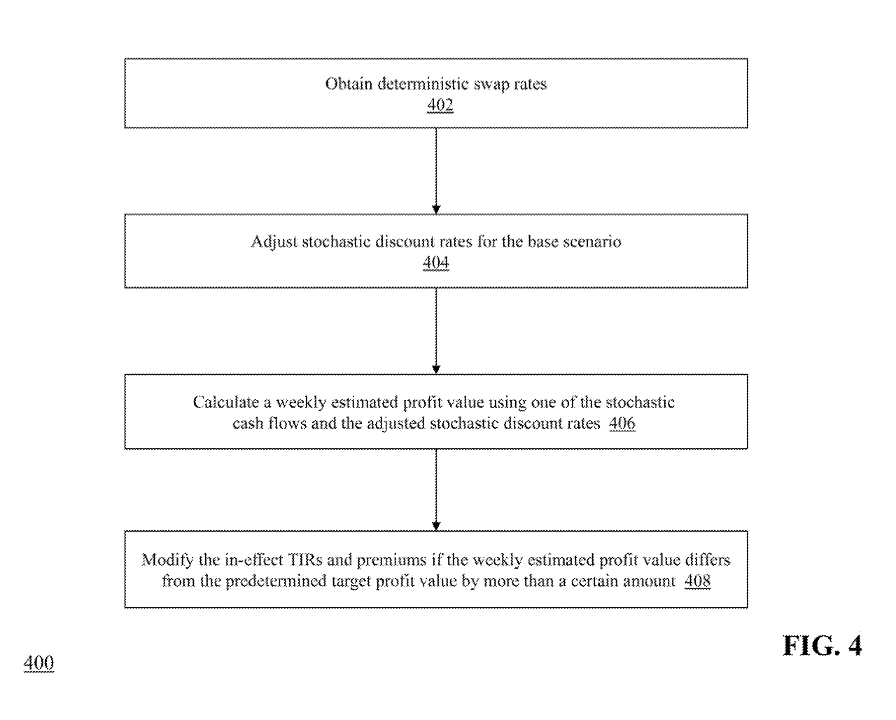

The following paragraphs will explain the steps of the method 200 in greater detail with reference to FIGS. 3-4. In step 202, the TIR determination module 104 determines an in-effect set of threshold interest rates for the guaranteed life insurance product based on a target profit value for the guaranteed life insurance product. The determination of the in-effect set of threshold interest rates referenced in step 202 can occur on a quarterly basis, and in some embodiments, occurs more frequently (e.g., each week). FIG. 3 is a detailed flow diagram of a method 300 for determining an in-effect set of threshold interest rates based on a target profit value.

The TIR determination module 104 determines (302) three sets of stochastic swap rates (base, shift up, and shift down scenarios).

In some embodiments, the target profit value is based on a determination of: Market Consistent Value of New Business (MCVNB) divided by Planned Annual Premium (PAP), subject to other profit constraints. In some embodiments, other profit measures such as International Financial Reporting Standards (IFRS) earnings and internal rate of return (IRR), are examined and can serve as constraints as to how much improvement can be applied to the TIRs.

A swap rate is based on the fixed portion of the underlying interest rate swap. Interest rate swaps commonly involve the exchange of fixed payments for variable floating payments that are linked to an interest rate (most often the London Interbank Offered Rate or LIBOR). For example, company A may have a bond that pays the LIBOR, and it wants to exchange those LIBOR payments (enter into a swap contract) for fixed rate payments from Company B. If for a particular duration the market expectation of LIBOR rates is such that paying LIBOR rates for that duration is valued equivalent to paying a fixed rate of say X % for that duration, then the swap rate for that duration is X %. A swap curve can be determined from the swap rates, where the swap curve is a representation of the swap rates for different durations (e.g., 2 months, 2 years, 20 years, etc.).

The base scenario assumes that the swap curve used to determine stochastic swap rates is unchanged. The shift up scenario assumes that the swap curve used to determine stochastic swap rates has been adjusted upward by a predetermined amount, while the shift down scenario assumes that the swap curve used to determine stochastic swap rates has been adjusted downward by an amount parallel to the amount in the shift up scenario.

The TIR determination module 104 also determines (304) three sets of stochastic discount rates (base, shift up, and shift down scenarios). The discount rate is an interest rate used to convert a future income stream to its present value. The base scenario assumes that the stochastic discount rate is unchanged. The shift up scenario assumes that the stochastic discount rate has been adjusted upward by a predetermined amount, while the shift down scenario assumes that the stochastic discount rate has been adjusted downward by an amount parallel to the amount in the shift up scenario.

The TIR determination module 104 then determines (306) a set of threshold interest rates and premiums for the guaranteed life insurance product for the base scenario by matching an estimated profit value to the predetermined target profit value. The calculation of the estimated profit value and associated matching to the predetermined target profit value occurs via an iterative process. The process involves (i) choosing values for the TIRs and premiums and supplying the values to the base stochastic scenario and (ii) running the base scenario with the chosen values to determine the estimated profit value. The estimated profit value is then compared to the predetermined target profit value. If the estimated profit value matches the predetermined target profit value, then the TIR determination module 104 uses the chosen TIR and premium values. If the estimated profit value does not match the predetermined target profit value, then the TIR and premium values are adjusted and the base scenario is run again with the new values. This process may occur many times in order to arrive at the optimal values for the TIRs and premiums.

The TIR determination module 104 then calculates (308) a set of stochastic cash flows for each of the three scenarios using the premiums resulting from the iterative process step 306. The cash flows represent the amount of income expected for the guaranteed life insurance product under each of the scenarios. The TIR determination module 104 calculates (310) a profit value for each of the three scenarios using the stochastic cash flows and corresponding stochastic discount rates (as determined in step 304).

The TIR determination module 104 then determines (312) a set of threshold interest rates and premiums for the guaranteed life insurance product for the shift up and shift down scenarios by matching an estimated profit value to the predetermined target profit value. As with the base scenario described above with respect to step 306, the calculation of the estimated profit value and associated matching to the predetermined target profit value for the shift up and shift down scenarios occurs via an iterative process. The process involves (i) choosing values for the TIRs and premiums and supplying the respective values to the shift up and shift down scenarios, and (ii) running the shift up and shift down scenarios with the chosen values to determine the estimated profit value. The estimated profit value is then compared to the predetermined target profit value. If the estimated profit value matches the predetermined target profit value, then the TIR determination module 104 uses the chosen TIR and premium values. If the estimated profit value does not match the predetermined target profit value, then the TIR and premium values are adjusted and the shift up and shift down scenarios are run again with the new values. This process may occur many times in order to arrive at the optimal values for the TIRs and premiums.

After the in-effect set of threshold interest rates has been determined by the process shown in FIG. 3, the threshold interest rates can be applied to applications for the guaranteed life insurance product that are received by the insurer. In some embodiments, at the time that the set of threshold interest rates are applied to a newly-received application, the policy illustration module 108 is used to generate an illustration using the set of threshold interest rates assigned to the application. An illustration contains hypothetical representations that reflect the critical assumptions the insurance company used to compute policy results. An illustration is a presentation or depiction that includes non-guaranteed elements of the policy over a period of years and can be one of several types:
(1) “Basic illustration” means a ledger or proposal used in the sale of a life insurance policy that shows both guaranteed and non-guaranteed elements;
(2) “Supplemental illustration” means an illustration furnished in addition to a basic illustration that meets the applicable regulation requirements, and that may be presented in a format differing from the basic illustration, but may only depict a scale of non-guaranteed elements that is permitted in a basic illustration; and
(3) “In-force illustration” means an illustration furnished at any time after the policy that it depicts has been in force for one year or more.

The policy illustration module 108 produces the illustration(s) for an agent and/or customer that submitted the application.

Referring back to FIG. 2, in step 206 the TIR determination module 104 periodically determines whether to modify the in-effect set of threshold interest rates. This periodic determination results in adjustments of the threshold interest rates on a much more frequent basis than the stochastic determinations referenced in FIG. 3—which provides the ability to have the in-effect threshold interest rates reflect current market conditions and respond dynamically to fluctuations in market conditions, leading to a more accurately priced insurance product. In some embodiments, the periodic determination is made on a weekly basis. FIG. 4 is a detailed flow diagram of a method 400 for determining, on a periodic basis, whether to modify the in-effect set of threshold interest rates based on a comparison of an estimated profit value to the target profit value.

The TIR determination module 104 obtains (402) deterministic swap rates. The TIR determination module 104 determines the deterministic swap rates using market information on at the money US dollar interest rate swap instruments for available maturities, along with longer term company set rates. The swap rates are derived from the market value of these securities for available maturities. Long term ultimate rates extrapolate from the last market point to an ultimate forward rate, which is set by the company.

The stochastic swap rates use the deterministic swap curve as their starting point for the mean expected swap rates. Market implied interest rate volatility assumptions are also derived from the interest rate swap instruments. These two pieces of market information are the key inputs that get fed into a scenario generator that uses the LIBOR Market Model method to generate a set of 1,000 stochastic scenarios.

The TIR determination module 104 then adjusts (404) the stochastic discount rates for the base scenario (previously determined in step 304 of FIG. 3). The adjustments are correlated to the movement of the deterministic swap rates in step 402. These adjustments to the base stochastic discount rates are calculated as parallel shifts by duration based on the change in the deterministic discount rate at that duration.

The TIR determination module 104 then calculates (406) an estimated profit value using one of the stochastic cash flows (as determined in step 308 of FIG. 3) and the adjusted stochastic discount rates determined in step 404. The quarterly stochastic scenario that is used is determined by calculating durational weights for each scenario based on its cash flows, then for each scenario take the difference at each duration between the weekly deterministic discount rates and the quarterly deterministic discount rates, then determine by means of a statistical best fit test which of the cash flow weighted differences is the best fit. The stochastic cash flow from that quarterly best fit scenario is used in combination with the weekly deterministic discount rate to calculate an estimated profit value.

The TIR determination module 104 then compares the estimated profit value calculated in step 406 to the predetermined target profit value. If the estimated profit value differs from the predetermined target profit value by more than a certain amount, then the TIR determination module 104 determines that the in-effect TIRs and associated product premiums should be modified (408). For example, if the estimated profit value falls below the predetermined target profit value by a certain amount (e.g., 10 basis points), then the TIRs and premiums should be modified to result in an estimated profit value that matches the predetermined target profit value. Similarly, if the estimated profit value exceeds the predetermined profit value by a certain amount, then the TIRs and premiums should be modified to result in an estimated profit value that matches the predetermined target profit value. Using this technique, the insurer has the ability to adjust the TIRs downward and/or premiums upward to compensate for lower swap rates and thus avoiding decreased profits —while at the same time the insurer has the ability to adjust the TIRs upward and/or premiums downward to compensate for higher swap rates and thus provide more attractive product terms for the consumer while maintaining its profit.

Referring back to FIG. 2, in step 208 the TIR determination module 104 calculates a modified in-effect set of threshold interest rates if it determines that the set of threshold rates is to be modified. To calculate the modified set of in-effect threshold interest rates, the TIR determination module 104 uses the weekly estimated profit value (determined in step 406 of FIG. 4), the profit values for each of the three scenarios (determined in step 310 of FIG. 3), the TIR for the base scenario (determined in step 306) and the TIRs for the shift up scenario and the shift down scenario (determined in step 312). The TIR determination module 104 determines the relationship between the TIR and the profit value for each of the three scenarios, then uses a linear relationship to estimate a modified TIR based on the weekly estimated profit value.

As an illustrative example, a target profit of 0.30 MCVNB/PAP is achieved with a TIR of 1.80%. (It should be noted that this example is a simplification because the TIR actually varies according to policy duration.) At the same time, the Shift Up scenario results in a 0.58 profit when using the same set of TIRs. It has also been determined that a TIR of 2.08% would bring the profit of the Shift Up scenario back down to the 0.30 target. A linear relationship between the TIR and profit is assumed, which in this example means a 0.01 decrease in profit per 1 basis point increase in TIR. So if, for example, the weekly profit is calculated to be 0.40, then the modified set of in-effect TIRs would be 1.90%

Once the TIR determination module 104 has calculated the modified in-effect set of threshold interest rates for the current week, the TIR determination module passes the modified set of threshold interest rates to the application processing module 106. The application processing module 106 then applies the modified set of threshold interest rates to newly-received applications. In addition, the application processing module 106 applies the modified set of threshold interest rates to applications that are issuing on the current date if the modified threshold interest rates are higher than the set of threshold interest rates assigned to the application.

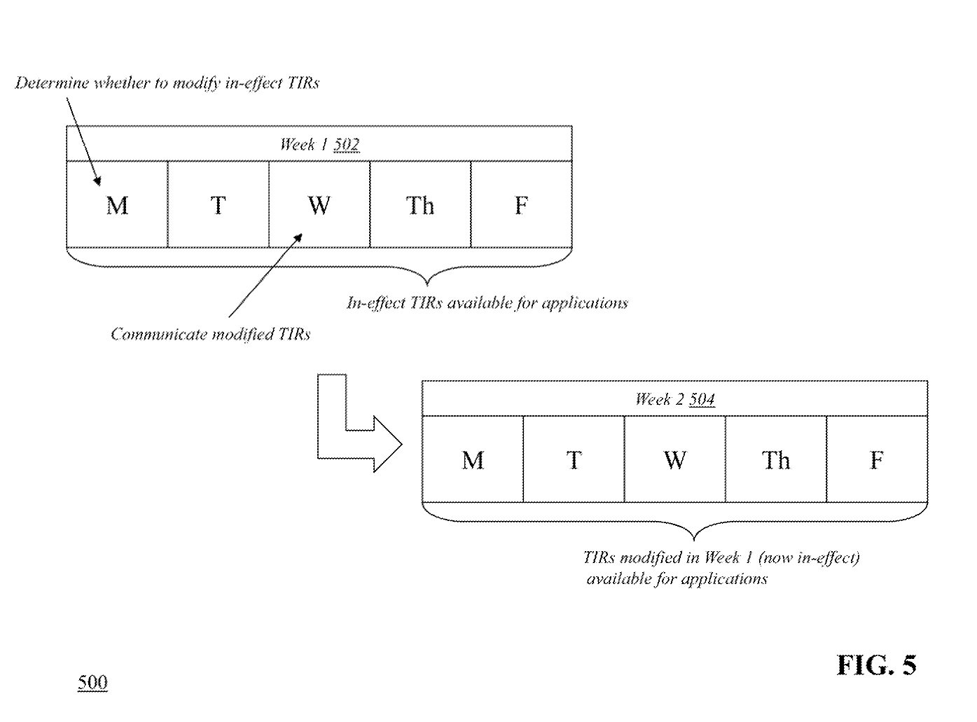

FIG. 5 is a block diagram of a timeline 500 for determining whether to modify the in-effect set of threshold interest rates and availability of the modified threshold interest rates to newly-received and issuing applications. During a given week (e.g., Week One 502), a set of in-effect threshold interest rates is available to be applied to newly-received applications and issuing applications. For example, if a new application for a particular guaranteed life insurance product is received by the insurer on any day (Monday through Friday) of Week One 502, the computing device 102 applies the currently in-effect set of threshold interest rates to the application. On Monday of Week One 502, the computing device 102 determines whether the currently in-effect set of threshold interest rates should be modified (as described with respect to FIGS. 2-4). In some embodiments, the computing device 102 uses swap rates and other information derived on Friday of the previous week.

If the computing device 102 modifies the in-effect set of threshold interest rates, the modified rates are released and communicated on Wednesday of Week One 502. The release and communication process can include transmission of the modified rates to other computing devices and/or storage of the rates in databases, preparation of correspondence with the modified rates to downstream entities, and the like. However, the modified set of threshold interest rates are not applicable to applications during Week One 502. Instead, the currently in-effect set of threshold interest rates remain applicable.

At the start of Week Two 504, the modified set of threshold interest rates (determined during Week One 502) become the in-effect set of threshold interest rates for Week Two 504. Applications that are newly-received or issuing during Week Two 504 use this set of threshold interest rates. Just like the previous week, the computing device 102 determines whether the currently in-effect set of threshold interest rates (e.g., the modified set of threshold interest rates from Week One 502) should be modified on Monday of Week Two 504, and releases/communicates the newly-modified rates if applicable on Wednesday of Week One 502, to go into effect during the following week. One reason for releasing/communicating the newly-modified rates several days before they go into effect is to allow agents that directly sell the insurance product to understand upcoming changes to the TIRs and advise their customers accordingly. For example, if the TIRs will go up during the following week, it may be beneficial for a customer to wait until then to submit an application instead of doing so during the current week.

As mentioned previously, the computing device 102 assigns the current week's in-effect set of TIRs to new applications received during that week. When the computing device 102 assigns the set of TIRs to a new application, the set of TIRs is locked in for a predetermined time period (also called the rate lock period). During the rate lock period (e.g., thirteen weeks), while the application is still pending, the set of TIRs assigned to the application does not change—even though the computing device 102 may modify the in-effect TIRs as set forth above. The rate lock period gives consumers an assurance that their assigned TIRs will not decrease between the time of application submission and the time that the application issues.

On the date that the insurer issues the application as a policy for the guaranteed life insurance product, the computing device 102 compares the set of TIRs previously assigned to the application with the currently in-effect set of TIRs. If the currently in-effect set of TIRs is higher than the previously-assigned set of TIRs, the computing device 102 updates the application to receive the currently in-effect set of TIRs. Conversely, if the currently in-effect set of TIRs is lower than the previously-assigned set of TIRs, the computing device 102 does not change the set of TIRs assigned to the application.

If the application has not yet issued at the end of the rate lock period, the locked-in rate expires. The computing device 102 assigns the currently in-effect set of TIRs to the application regardless of whether the currently in-effect TIRs are higher or lower than the previously-assigned TIRs, and a new rate lock period begins. In some embodiments, the application processing module 106 of the computing device 102 determines a warning period (e.g., ten days) prior to the expiry of the rate lock period and generates communications (e.g., a printed letter) to be delivered to the agent/customer notifying them that the rate lock period is about to end. The determination of the warning period and generation of communications can occur automatically based on the configuration of the computing device 102. Electronic copies of the communications can also be stored in a document repository and/or transmitted to a website for presentation to the agent/customer.

The following are several examples of how assignment of TIRs to applications occurs in conjunction with the rate lock process:

### Example 1

May 1—A formal, complete application for Client A is received. The rate lock date for the application is set to May 1, and the currently in-effect TIR of 3.17% is assigned to the application and locked in for the rate lock period, e.g., thirteen weeks.

June 2—The TIR changes to 3.25%. This has no effect on the TIR of 3.17% presently assigned to the application.

June 5—Client A's application is issued. The computing device 102 compares the currently assigned TIR of 3.17% against the TIR in effect as of June 5 (3.25%) and issues the policy using the higher 3.25% threshold interest rate. A new illustration with the correct threshold interest rate is delivered to the agent/customer.

### Example 2

June 18—A formal, complete application for Client B is received. The rate lock date for the application is set to June 18, and the currently in-effect TIR of 3.25% is assigned to the application and locked in for the rate lock period, e.g., thirteen weeks.

June 29—The computing device 102 modifies the TIR to 3.01%.

July 15—The computing device 102 modifies the TIR to 3.15%.

July 22—Client B's application is issued. The computing device 102 compares the currently assigned TIR of 3.25% against the TIR in effect as of July 22 (3.15%) and issues the policy using the locked-in 3.25% threshold interest rate.

### Example 3

June 18—A formal, complete application for Client C is received. The rate lock date for the application is set to June 18, and the currently in-effect TIR of 3.25% is assigned to the application and locked in for the rate lock period, e.g., thirteen weeks.

June 29—The computing device 102 modifies the TIR to 3.01%.

July 15—The computing device 102 modifies the TIR to 3.15%.

August 3—The computing device 102 modifies the TIR to 3.08%.

August 24—The computing device 102 modifies the TIR to 3.02%.

September 12—The document generation module 110 generates a rate lock expiry notification letter and sends the letter to the agency that submitted the application. An electronic copy of the letter is also stored in a document repository.

September 13—The computing device 102 modifies the TIR to 3.15%.

September 19—The June 18 rate lock period expires. The rate lock date is changed to September 19. The computing device 102 assigns the currently in-effect TIR (3.15%) to the application and locks in the TIR for another thirteen weeks.

September 19—Client C's application is issued. The computing device 102 compares the currently assigned TIR of 3.15% against the TIR in effect as of September 13 (3.15%) and issues the policy using the locked-in 3.15% threshold interest rate.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, a 3GPP Long Term Evolution (LTE) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, tablet device, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device includes, for example, a Blackberry®, an iPhone®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for dynamically determining a set of threshold interest rates associated with a guaranteed life insurance product, the method comprising:
determining, by a computing device, an in-effect set of threshold interest rates for the guaranteed life insurance product based on a target profit value for the guaranteed life insurance product;
applying, by the computing device, the in-effect set of threshold interest rates to an application for the guaranteed life insurance product upon receipt of the application;
determining, by the computing device on a periodic basis, whether to modify the in-effect set of threshold interest rates based on a comparison of an estimated profit value of the guaranteed life insurance product to the target profit value;
if the computing device determines that the in-effect set of threshold interest rates is to be modified:
calculating, by the computing device, a modified set of threshold interest rates; and
applying, by the computing device, the modified set of threshold interest rates to the application for the guaranteed life insurance product on an issuance date of the product, if the modified set of threshold interest rates is higher than the set of threshold interest rates currently applied to the application.

2. The method of claim 1, wherein determining whether to modify the in-effect set of threshold interest rates comprises:
determining, by the computing device, the estimated profit value using a correlated scenario based on market information associated with a current period;
comparing, by the computing device, the estimated profit value with the target profit value; and
determining, by the computing device, to modify the in-effect set of threshold interest rates if the estimated profit value differs from the target profit value by more than a sufficient amount.

3. The method of claim 2, wherein the market information includes a set of swap curves.

4. The method of claim 2, wherein the target profit value represents a profit measure set periodically.

5. The method of claim 2, wherein determining the estimated profit value further includes:
determining, by the computing device, a shift-down profit value using a correlated scenario based on lower market values; and
determining, by the computing device, a shift-up profit value using a correlated scenario based on higher market values.

6. The method of claim 5, wherein the calculation of the modified set of threshold interest rates is based on the estimated profit value, the shift-down profit value, and/or the shift-up profit value.

7. The method of claim 1, wherein determining an in-effect set of threshold interest rates comprises:
determining, by the computing device, the target profit value using a stochastic scenario based on market values from the most recent quarter;
determining, by the computing device, a second profit value using a correlated scenario based on market values from the most recent quarter; and
calculating, by the computing device, the in-effect set of threshold interest rates based on the target profit value and the second profit value.

8. The method of claim 7, further comprising:
determining, by the computing device, a shift-down set of threshold interest rates using a stochastic scenario based on lower market values; and
determining, by the computing device, a shift-up set of threshold interest rates using a stochastic scenario based on higher market values.

9. The method of claim 1, wherein determining an in-effect set of threshold interest rates further includes determining an in-effect premium rate for the guaranteed life insurance product.

10. The method of claim 1, wherein applying the in-effect set of threshold interest rates to an application further includes locking in the in-effect set of threshold interest rates for a predetermined period of time (rate lock period).

11. The method of claim 1, wherein determining whether to modify the in-effect set of threshold interest rates is performed on a weekly basis.

12. The method of claim 1, further comprising:
generating an illustration associated with the application for the guaranteed life insurance product, wherein the illustration includes information associated with the in-effect set of threshold interest rates and/or the modified set of threshold interest rates; and
transmitting, by the computing device, the illustration to a remote computing device.

13. The method of claim 1, wherein the modified set of threshold interest rates takes effect several days after the calculation of the modified set of threshold interest rates is performed.

14. The method of claim 13, wherein the modified set of threshold interest rates is transmitted to a remote computing device before taking effect.

15. The method of claim 1, wherein applying the in-effect set of threshold interest rates further comprises:
assigning, by the computing device, a rate lock date to the application based on the date that the application is received; and
determining, by the computing device, a rate lock expiry date based on the rate lock date and a rate lock period.

16. The method of claim 15, further comprising:
generating, by the computing device, printed correspondence including the rate lock date and the rate lock expiry date upon receipt of the application; and
transmitting, by the computing device, electronic copies of the printed correspondence to an electronic record retention system and to a website.

17. The method of claim 16, further comprising:
determining, by the computing device, a warning period prior to the rate lock expiry date; and
triggering, by the computing device, the steps of generating printed correspondence and transmitting electronic copies if the current date falls within the warning period.

18. The method of claim 15, further comprising:
if the application is still pending and the rate lock period has expired:
assigning, by the computing device, a new rate lock date to the application; and
determining, by the computing device, a new rate lock expiry date based on the new rate lock date and a rate lock period.

19. The method of claim 18, further comprising:
generating, by the computing device, printed correspondence including the new rate lock date and the new rate lock expiry date; and
transmitting, by the computing device, electronic copies of the printed correspondence to an electronic record retention system and to a website.

20. The method of claim 19, further comprising:
determining, by the computing device, a warning period prior to the new rate lock expiry date; and
triggering, by the computing device, the steps of generating printed correspondence and transmitting electronic copies if the current date falls within the warning period.

21. A computerized system for dynamically determining a set of threshold interest rates associated with a guaranteed life insurance product, the computerized system comprising a computing device configured to:
determine an in-effect set of threshold interest rates for the guaranteed life insurance product based on a target profit value for the guaranteed life insurance product;
apply the in-effect set of threshold interest rates to an application for the guaranteed life insurance product upon receipt of the application;
determine, on a periodic basis, whether to modify the in-effect set of threshold interest rates based on a comparison of an estimated profit value of the guaranteed life insurance product to the target profit value;
if the computing device determines that the in-effect set of threshold interest rates is to be modified:
calculate a modified set of threshold interest rates; and
apply the modified set of threshold interest rates to the application for the guaranteed life insurance product on an issuance date of the product, if the modified set of threshold interest rates is higher than the set of threshold interest rates currently applied to the application.

22. A computer program product tangibly embodied in a non-transitory computer readable medium, for dynamically determining a set of threshold interest rates associated with a guaranteed life insurance product, the computer program product including instructions operable to cause a data processing apparatus to:
determine an in-effect set of threshold interest rates for the guaranteed life insurance product based on a target profit value for the guaranteed life insurance product;
apply the in-effect set of threshold interest rates to an application for the guaranteed life insurance product upon receipt of the application;
determine, on a periodic basis, whether to modify the in-effect set of threshold interest rates based on a comparison of an estimated profit value of the guaranteed life insurance product to the target profit value;
if the apparatus determines that the in-effect set of threshold interest rates is to be modified:
calculate a modified set of threshold interest rates; and
apply the modified set of threshold interest rates to the application for the guaranteed life insurance product on an issuance date of the product, if the modified set of threshold interest rates is higher than the set of threshold interest rates currently applied to the application.

23. A system for dynamically determining a set of threshold interest rates associated with a guaranteed life insurance product, the system comprising:
means for determining an in-effect set of threshold interest rates for the guaranteed life insurance product based on a target profit value for the guaranteed life insurance product;
means for applying the in-effect set of threshold interest rates to an application for the guaranteed life insurance product upon receipt of the application;
means for determining, on a periodic basis, whether to modify the in-effect set of threshold interest rates based on a comparison of an estimated profit value of the guaranteed life insurance product to the target profit value;
if the system determines that the in-effect set of threshold interest rates is to be modified:
means for calculating a modified set of threshold interest rates; and
means for applying the modified set of threshold interest rates to the application for the guaranteed life insurance product on an issuance date of the product, if the modified set of threshold interest rates is higher than the set of threshold interest rates currently applied to the application.
